(19) United States
(12) Patent Application Publication
(10) Pub. No.: US 2016/0189909 A1
(43) Pub. Date: Jun. 30, 2016

(54) TARGET FOR X-RAY GENERATION AND X-RAY GENERATION DEVICE

(71) Applicant: TOKYO ELECTRON LIMITED, Tokyo (JP)

(72) Inventors: Yoshiki YAMANISHI, Nirasaki City, Yamanashi (JP); Katsuji KADOSAWA, Nirasaki City, Yamanashi (JP)

(21) Appl. No.: 14/908,426

(22) PCT Filed: Jul. 8, 2014
(86) PCT No.: PCT/JP2014/068204

§ 371 Date: Jan. 28, 2016

(30) Foreign Application Priority Data
Jul. 30, 2013 (JP) 2013-158130

(51) Int. Cl. H01J 35/08; H01J 35/14

(52) U.S. Cl. CPC H01J 35/08; H01J 35/14; H01J 2235/086

(57) ABSTRACT

A target for X-ray generation includes a substrate, a first X-ray target portion formed on an upper surface of the substrate, and a second X-ray target portion formed at a position surrounding the first X-ray target portion in the upper surface of the substrate, while being spaced from an outer edge of the first X-ray target portion.

### TECHNICAL FIELD

Various aspects and embodiments of the present disclosure relate to a target for x-ray generation and an X-ray generation device.

### BACKGROUND

An X-ray generation device is used in a variety of fields including X-ray nondestructive inspection and so on. The X-ray generation device includes an electron beam emitter for emitting an electron beam, and a target for X-ray generation irradiated by the electron beam emitted from the electron beam emitter. The X-ray generation device emits an X-ray by impinging the electron beam, which is emitted from the electron beam emitter, onto the target for X-ray generation.

In this case, the target for X-ray generation includes a substrate and a target portion embedded in the substrate. For example, there is a method of using an FIB (Focused Ion Beam) processing apparatus to fabricate a target for X-ray generation.

The FIB processing apparatus is used to form a bottomed hole in a substrate by sputtering the substrate through irradiation of an ion beam onto the substrate. Then, a target portion is formed by depositing metal on the bottomed hole by irradiating the bottomed hole with an ion beam while supplying a material gas of the target for X-ray generation in the vicinity of the bottomed hole.

### PRIOR ART DOCUMENTS

### Patent Documents

Patent Document 1: Japanese Patent Application Publication No. 2011-77027

However, the above-described conventional technique can not use X-rays having different resolutions since the X-ray resolution is uniquely determined depending on the size of the target portion. In addition, a method in which a large target portion is formed in a substrate of a target for X-ray generation and then the diameter of an electron beam which irradiates the target portion is increased or decreased may be considered. However, it is technically difficult to thin the electron beam.

### SUMMARY

According to one embodiment of the present disclosure, there is provided a target for X-ray generation including: a substrate; a first X-ray target portion formed on an upper surface of the substrate; and a second X-ray target portion formed at a position surrounding the first X-ray target portion in the upper surface of the substrate, while being spaced from an outer edge of the first X-ray target portion.

According to one embodiment, there is an advantage that it is possible to use X-rays having different resolutions.

### BRIEF DESCRIPTION OF THE DRAWINGS

FIG. 1 is a view for explaining the sectional configuration of a target for X-ray generation according to a first embodiment.

FIG. 2 is an exploded perspective view of the target for X-ray generation according to the first embodiment.

FIG. 3 is a view for explaining the sectional configuration of the target for X-ray generation according to the first embodiment.

FIG. 4 is a view showing one example of the schematic configuration of an FIB apparatus according to the first embodiment.

FIG. 5 is a flowchart for explaining one example of a process of fabricating the target for X-ray generation according to the first embodiment.

FIG. 6A is a view for explaining one example of a process of fabricating the target for X-ray generation according to the first embodiment.

FIG. 6B is a view for explaining one example of a process of fabricating the target for X-ray generation according to the first embodiment.

FIG. 6C is a view for explaining one example of a process of fabricating the target for X-ray generation according to the first embodiment.

FIG. 7 is a view showing the sectional configuration of an X-ray generation device according to the first embodiment.

FIG. 8 is a view showing the configuration of a mold power supply unit according to the first embodiment.

FIG. 9 is a view showing the relationship between the beam diameter of an electron beam irradiating the target for X-ray generation, a first X-ray target portion and a second X-ray target portion.

FIG. 10 is a view showing the relationship between the beam diameter of an electron beam irradiating the target for X-ray generation, a first X-ray target portion and a second X-ray target portion.

FIG. 11 is a view showing one example of the target for X-ray generation in an embodiment where second X-ray target portions are provided.

FIG. 12 is a view showing one example of the second X-ray target portion.

FIG. 13 is a view showing one example of the second X-ray target portion.

FIG. 14 is a view showing one example of the second X-ray target portion.

FIG. 15 is a view for explaining one example of the sectional configuration of the target for X-ray generation.

### DETAILED DESCRIPTION

### First Embodiment

An X-ray generation device according to a first embodiment includes a substrate, an electron beam irradiation unit and a beam diameter controller in one embodiment. The electron beam irradiation unit irradiates, with an electron beam, a target for X-ray generation having a first X-ray target portion formed on an upper surface of the substrate and a second X-ray target portion which is formed at a position surrounding the first X-ray target portion on the upper surface of the substrate, while being spaced from an outer edge of the first X-ray target portion. The beam diameter controller controls a beam diameter of the electron beam irradiating the target for X-ray generation. In addition, the beam diameter controller allows a first X-ray, which indicates resolution corresponding to the size of the first X-ray target portion, to be emitted from the target for X-ray generation, by setting a beam diameter to a size at which an irradiation range becomes a range including the first X-ray target portion but not including the second X-ray target portion. In addition, the beam diameter controller allows a second X-ray, which indicates resolution lower than the resolution of the first X-ray, to be emitted from the target for X-ray generation, by setting the beam diameter to a size at which an irradiation range becomes a range including the first X-ray target portion and the second X-ray target portion.

A target for X-ray generation according to the first embodiment includes a substrate, a first X-ray target portion formed on an upper surface of the substrate, and a second X-ray target portion which is formed at a position surrounding the first X-ray target portion in the upper surface of the substrate, while being spaced from an outer edge of the first X-ray target portion, in one embodiment.

In the target for X-ray generation according to the first embodiment, the second X-ray target portion is formed in a ring shape whose center is a position at which the first X-ray target portion is formed.

In the target for X-ray generation according to the first embodiment, the first X-ray target portion and the second X-ray target portion are buried in bottomed hole portions formed in the substrate, in one embodiment.

Various embodiments of the present disclosure will hereinafter be described in detail with reference to the accompanying drawings. Throughout the drawings, the same or similar elements and portions are denoted by the same reference numerals.

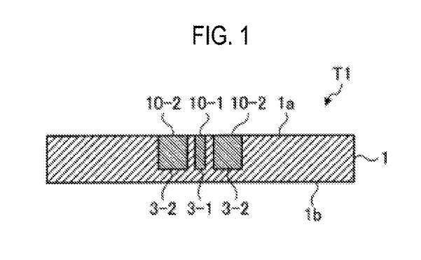

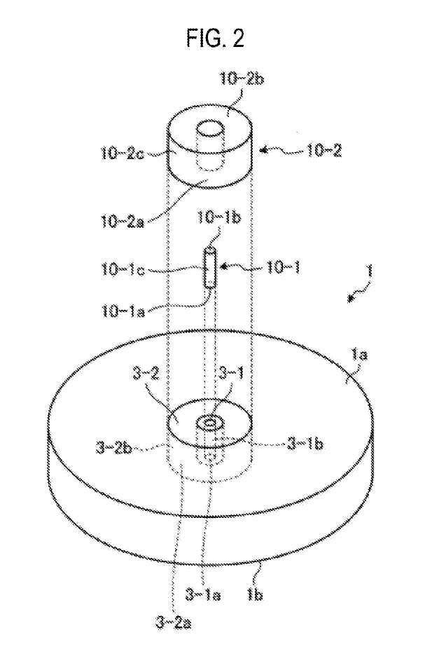

A target for X-ray generation T1 according to the first embodiment will now be described with reference to FIGS. 1 and 2. FIG. 1 is a view for explaining the sectional configuration of the target for X-ray generation according to the first embodiment. FIG. 2 is an exploded perspective view of the target for X-ray generation according to the first embodiment.

As shown in FIGS. 1 and 2, the target for X-ray generation T1 includes a substrate 1, a first X-ray target portion 10-1 and a second X-ray target portion 10-2.

The substrate 1 is made of diamond and formed in a disc shape. The substrate 1 has a front surface 1a and a rear surface 1b. The substrate 1 is not limited to the disc shape but may be formed in other shapes, for example, a rectangular shape. The thickness of the substrate 1 is set to, for example, about 100 μm. The outer diameter of the substrate 1 is set to, for example, about 3 mm.

Thus, when a bottomed hole 3-1 and a bottomed hole 3-2 are formed in the diamond, it is possible to efficiently diffuse heat produced during X-ray generation and thus to apply a large current.

The hole 3-1 and the hole 3-2 are formed in the front surface 1a of the substrate 1. The hole 3-1 has an inner space defined by the bottom face 3-1a and the side wall face 3-1b. The hole 3-2 has an inner space defined by the bottom face 3-2a and the side wall face 3-2b. The hole 3-2 is provided in the outer side of the hole 3-1 in the front surface 1a of the substrate 1. The inner space of the hole 3-1 is formed in, for example, a cylindrical shape. However, the inner space of the hole 3-1 is not limited to the cylindrical shape but may be formed in an arbitrary shape, for example, a prismatic shape. The inner space of the hole 3-2 is formed at a position surrounding the hole 3-1 in the upper surface of the substrate 1, while being spaced from the outer edge of the hole 3-1. For example, the inner space of the hole 3-2 is formed in a ring shape whose center is the hole 3-1.

Here, the relationship between the diameter of the hole 3-1, the inner diameter of the hole 3-2, and the beam diameter of an electron beam irradiating the target for X-ray generation T1 by an X-ray generation device will be described. The X-ray generation device irradiates the target for X-ray generation T1 with electron beams having at least two types of beam diameters. The electron beams emitted by the X-ray generation device, which have smaller diameters compared with other electron beams, have diameters larger than the diameter of the hole 3-1 and smaller than the inner diameter of the hole 3-2. On the other hand, the electron beams emitted by the X-ray generation device, which have larger diameters compared with other electron beams, have diameters larger than the inner diameter of the hole 3-2. That is, the X-ray generation device irradiates the target for X-ray generation T1 with the electron beam having the beam diameter larger than the diameter of the hole 3-1 and smaller than the inner diameter of the hole 3-2 or irradiates the target for X-ray generation T1 with the electron beam having the beam diameter larger than the inner diameter of the hole 3-2.

The diameter of the hole 3-1 is set to, for example, about 100 nm. The depth of the hole 3-1 is set to, for example, about 1 μm. Thus, the hole 3-1 is formed to have a small diameter and a large aspect ratio. The inner diameter of the hole 3-2 is set to, for example, about 300 nm and the outward shape of the hole 3-2 is set to an arbitrary value.

The first X-ray target portion 10-1 is formed in the upper surface of the substrate 1. For example, the first X-ray target portion 10-1 is buried in the bottomed hole 3-1 formed in the substrate 1. In the example shown in FIGS. 1 and 2, the first X-ray target portion 10-1 is disposed in the hole 3-1 formed in the substrate 1. The first X-ray target portion 10-1 is made of metal and is formed in a cylindrical shape corresponding to the inner space of the hole 3-1. The first X-ray target portion 10-1 has a first end face 10-1a, a second end face 10-1b and an outer face 10-1c. An example of the metal making up the first X-ray target portion 10-1 may include copper, molybdenum, tungsten, platinum or the like.

The first X-ray target portion 10-1 is formed by depositing the metal from the bottom face 3-1a of the hole 3-1 toward the front surface 1a. As a result, the entire first end face 10-1a of the first X-ray target portion 10-1 makes close contact with the bottom face 3-1a of the hole 3-1. The outer face 10-1c of the first X-ray target portion 10-1 is entirely in close contact with the side wall face 3-1b of the hole 3-1.

The first X-ray target portion 10-1 is formed to correspond to the shape of the inner space of the hole 3-1. The axial length in the cylindrical shape of the first X-ray target portion 10-1 is, for example, about 1 μm. The radial length in the cylindrical shape of the first X-ray target portion 10-1 is, for example, about 100 nm.

The second X-ray target portion 10-2 is formed at a position surrounding the first X-ray target portion 10-1 in the upper surface of the substrate 1, while being spaced from the outer edge of the first X-ray target portion 10-1. For example, the second X-ray target portion 10-2 is buried in the bottomed hole 3-2 formed in the substrate 1.

In the example, shown in FIGS. 1 and 2, the second X-ray target portion 10-2 is disposed in the hole 3-2 formed in the substrate 1. The second X-ray target portion 10-2 is made of metal and is formed in a cylindrical shape corresponding to the inner space of the hole 3-2. The second X-ray target portion 10-2 has a first end face 10-2a, a second end face 10-2b and an outer face 10-2c. An example of the metal making up the second X-ray target portion 10-2 may include tungsten, gold, platinum or the like.

The second X-ray target portion 10-2 is formed by depositing the metal from the bottom face 3-2a of the hole 3-2 toward the front surface 1a. As a result, the first end face 10-2a of the second X-ray target portion 10-2 is entirely in close contact with the bottom face 3-2a of the hole 3-2. The outer face 10-2c of the second X-ray target portion 10-2 is entirely in close contact with the side wall face 3-2b of the hole 3-2.

The second X-ray target portion 10-2 is formed to correspond to the shape of the inner space of the hole 3-2. The axial length in the cylindrical shape of the second X-ray target portion 10-2 is, for example, about 1 μm. The radial length in the cylindrical shape of the inner diameter of the second X-ray target portion 10-2 is, for example, about 300 nm.

Here, the first X-ray target portion 10-1 and the second X-ray target portion 10-2 may be made of the same metal or different metal. In addition, the first X-ray target portion 10-1 and the second X-ray target portion 10-2 may be formed by the same process or different processes.

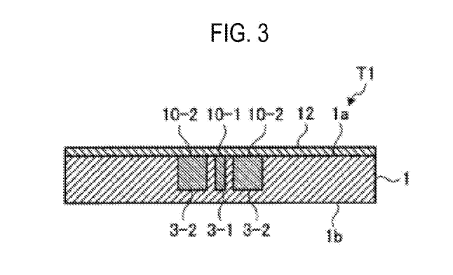

FIG. 3 is a view for explaining the sectional configuration of the target for X-ray generation according to the first embodiment. As shown in FIG. 3, the target for X-ray generation T1 may include a conductive layer 12. The conductive layer 12 is formed in a film shape on the front surface 1a of the substrate 1. The conductive layer 12 is made of diamond doped with impurities (for example, boron). The thickness of the conductive layer 12 is, for example, about 50 nm.

The conductive layer 12 shown in FIG. 3 is formed on the front surface 1a of the substrate 1 such that it covers the front surface 1a of the substrate 1, the second end face 10-1b of the first X-ray target portion 10-1 and, the second end face 10-2b of the second X-ray target portion 10-2.

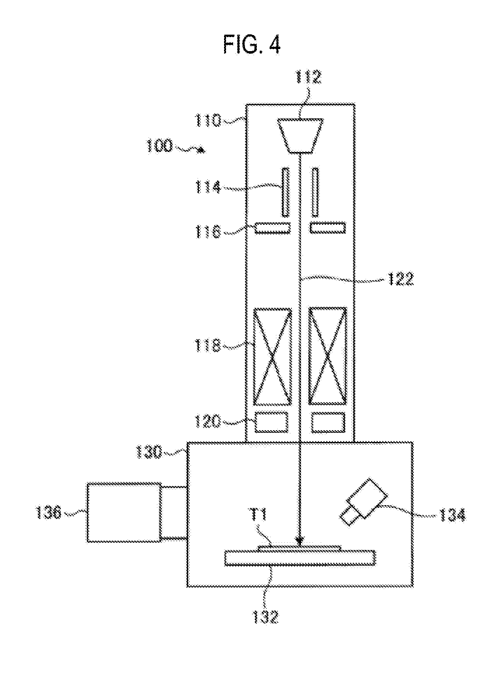

Subsequently, a FIB apparatus for fabricating the target for X-ray generation T1 will be described by way of example FIG. 4 is a view showing one example of the schematic configuration of the FIB apparatus. The FIB apparatus shown in FIG. 4 is just one example. A FIB apparatus used to fabricate the target for X-ray generation according to the embodiment is not limited to the FIB apparatus shown in FIG. 4 but may be any other FIB apparatus. In addition, an apparatus used to fabricate the target for X-ray generation T1 is not limited to a FIB apparatus but may be any other apparatus.

As shown in FIG. 4, the FIB apparatus 100 includes a liquid metal ion source reservoir 112, a blanker 114, an aperture 116, a scanning electrode 118 and an objective lens 120, which are accommodated in a first housing 110. In addition, the FIB apparatus 100 includes a mounting table 132 and a gas gun 134, which are accommodated in a second housing 130 connected to the first housing 110. Furthermore, the FIB apparatus 100 includes a pump 136 connected to the second housing 130.

The liquid metal ion source reservoir 112 stores, for example, a Ga liquid metal ion source. The blanker 114 is a deflector for deflecting an ion beam emitted from the liquid metal ion source reservoir 112. For example, when the ion beam is emitted, the blanker 114 switches the emitted ion beam from a state (an ON state) where the ion beam irradiates the hole 3-1 or the hole 3-2 to a state (an OFF state) obtainable by deflecting the ion beam where the ion beam does not irradiate the hole 3-1 or the hole 3-2.

The aperture 116 selectively limits the current of the ion beam emitted from the liquid metal ion source reservoir 112 by an aperture hole. The scanning electrode 118 allows the ion beam, which is emitted from the liquid metal ion source reservoir 112, to scan the hole 3-1, corresponding to the diameter of the hole 3-1 of the substrate 1. The objective lens 120 focuses the ion beam emitted from the liquid metal ion source reservoir 112.

The mounting table 132 mounts the target for X-ray generation T1. The gas gun 134 sprays a material gas into an inner space of the second housing 130 in forming the first X-ray target portion 10-1 and second X-ray target portion 10-2 of the target for X-ray generation T1. An example of the material gas may include tungsten hexacarbonyl (W(CO)₆). The pump 136 performs evacuation so that the first housing 110 and the second housing 130 can be held in a predetermined vacuum state.

The FIB apparatus 100 irradiates the target for X-ray generation T1 with an ion beam 122 from liquid metal ion source reservoir 112 via the blanker 114, the aperture 116, the scanning electrode 118 and the objective lens 120.

Here, the FIB apparatus 100 forms the hole 3-1 and the hole 3-2 by irradiating and sputtering the substrate 1 with the ion beam 122 while scanning the substrate 1.

### (One Example of Flow of Fabrication Process)

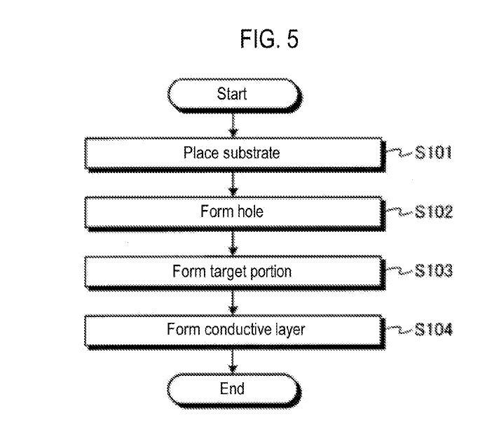

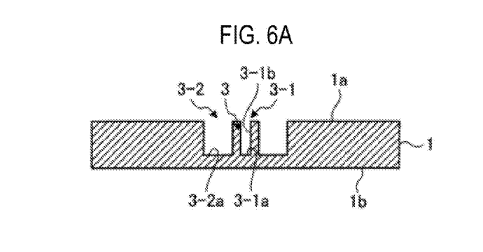

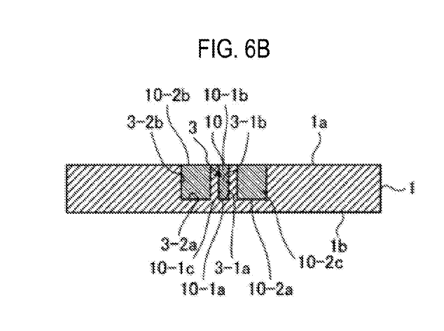

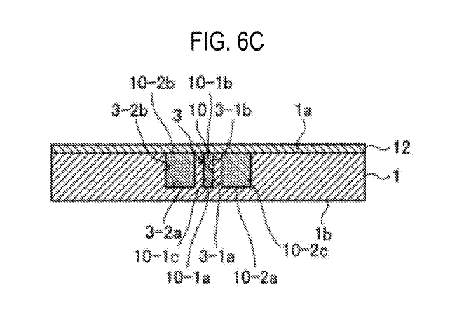

FIG. 5 is a flowchart for explaining one example of a process of fabricating the target for X-ray generation according to the first embodiment. FIGS. 6A to 6C are views for explaining one example of a process of fabricating the target for X-ray generation according to the first embodiment. Although a case where the FIB (Focused Ion Beam) processing apparatus is used to fabricate the target for X-ray generation is described below by way of example, the present disclosure is not limited thereto.

As shown in FIG. 5, the substrate 1 is mounted on the mounting table 132 of the FIB apparatus 100 (Step S101). Then, the FIB apparatus 100 forms the hole 3-1 and the hole 3-2 on the substrate 1 (Step S102). Specifically, the FIB apparatus 100 forms the bottomed hole 3-1 and the bottomed hole 3-2 on the substrate 1. For example, the FIB apparatus 100 forms the hole 3-1 and the hole 3-2 in the substrate 1, as shown in FIG. 6A, by sputtering the substrate 1 from the side of the front surface 1a by irradiating the substrate 1 with the ion beam 122 such as Ga+. For example, the FIB apparatus 100 forms the hole 3-1 having the diameter of 100 nm and the depth of 600 nm and the ring-like hole 3-2 having the inner diameter of 300 nm, the outward dimension of 600 nm and the depth of 600 nm on the substrate 1. However, the present disclosure is not limited thereto. For example, the diameter of the hole 3-1 may be smaller than 100 nm and the depths of the hole 3-1 and the hole 3-2 may be larger than 600 nm.

Here, the hole 3-1 and the hole 3-2 formed by sputtering the substrate 1 using the ion beam 122 may decrease in diameter from the top toward the bottom face 3-1a and the bottom face 3-2a, respectively, so that the side wall face 3-1b and the side wall face 3-2b are formed in a tapered shape. For convenience of description, a case where the side wall face 3-1b is formed perpendicular to the bottom face 3-1a and the side wall face 3-2b is formed perpendicular to the bottom face 3-2a is described in the example shown in FIG. 6A.

Then, target portions are formed (S103). Specifically, as shown in FIG. 6B, the first X-ray target portion 10-1 is formed in the hole 3-1 and the second X-ray target portion 10-2 is formed in the hole 3-2. For example, the first X-ray target portion 10-1 is formed by depositing the above-mentioned metal from the bottom face 3-1a of the hole 3-1 toward the first main surface 1a. In addition, the second X-ray target portion 10-2 is formed by depositing the above-mentioned metal from the bottom face 3-2a of the hole 3-2 toward the first main surface 1a. Here, the metal is directly deposited into the hole 3-1 and the hole 3-2. As a result, in the first X-ray target portion 10-1, the first end face 10-1a is in close contact with the bottom face 3-1a of the hole 3-1 and the outer face 10-1c is in close contact with the side wall face 3-1b of the hole 3-1. Similarly, in the second X-ray target portion 10-2, the second end face 10-2a is in close contact with the bottom face 3-2a of the hole 3-2 and the outer face 10-2c is in close contact with the side wall face 3-2b of the hole 3-2.

For example, the FIB processing apparatus is used to deposit the metal by irradiating a converged ion beam at the hole 3-1 and the hole 3-2 under a metal vapor atmosphere. The FIB processing apparatus deposits a material by FIB excited chemical vapor deposition by spraying a material gas into a place irradiated with the converged ion beam. For example, tungsten can be deposited by using tungsten hexacarbonyl (W(CO)₆) as the material gas. As another example, platinum may be deposited using trimethyl(methylcyclopentadienyl)platinum as the material gas. As another example, gold may be deposited using dimethylgoldhexafluoroacetylacetonate (C₇H₇F₆O₂Au) as the material gas.

Then, the conductive layer 12 is formed (Step S104). The conductive layer 12 is formed to cover the front surface 1a of the substrate 1 and the top portion of the metal deposited in the hole 3-1 and the hole 3-2. The conductive layer 12 is formed, for example using a known microwave plasma CVD apparatus. In more detail, the conductive layer 12 is formed by generating and growing diamond particles in the front surface 1a and the top portion of the metal while doping with boron by means of a microwave plasma CVD process using the microwave plasma CVD apparatus. Alternatively, the conductive layer 12 is formed, for example using a known PVD (Physical Vapor Deposition) apparatus. In more detail, the conductive layer 12 is formed by depositing a conductive metal film on the front surface 1a and the top portion of the metal by means of the PVD apparatus. The conductive metal film is made of metal such as titanium or chromium and its thickness is, for example, 50 nm. However, the present disclosure is not limited thereto. The conductive metal film may be made of material other than titanium and chromium and the film thickness may be smaller or larger than 50 nm. As a result, as shown in FIG. 6C, the conductive layer 12 is formed on the front surface 1a of the substrate 1.

The processing procedure of the fabrication process described with reference to FIGS. 5 and 6 is not limited to the above-described order but may be changed as appropriate as long as the processing procedure is not contradictory to the processing purpose. For example, Step S104 may be omitted or may be performed before Step S102.

### (One Example of X-Ray Generation Device)

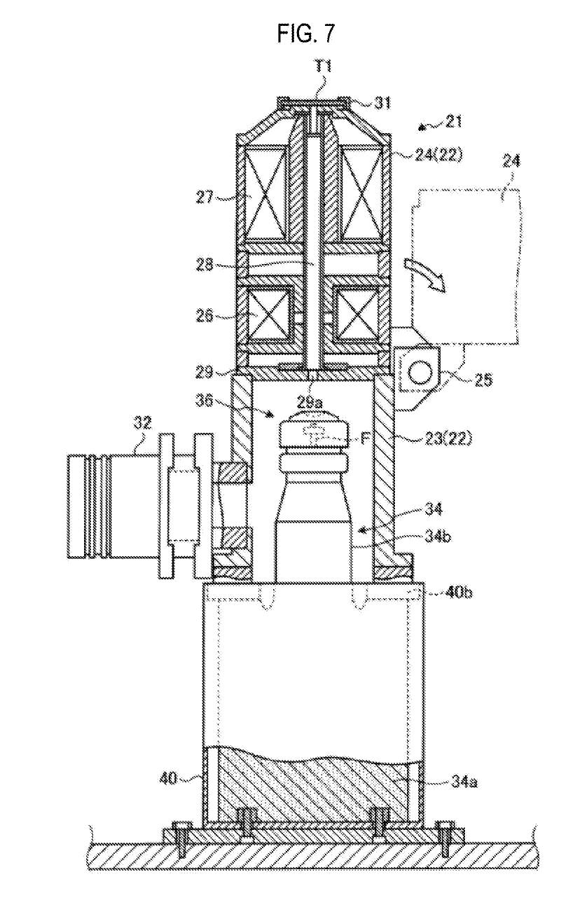

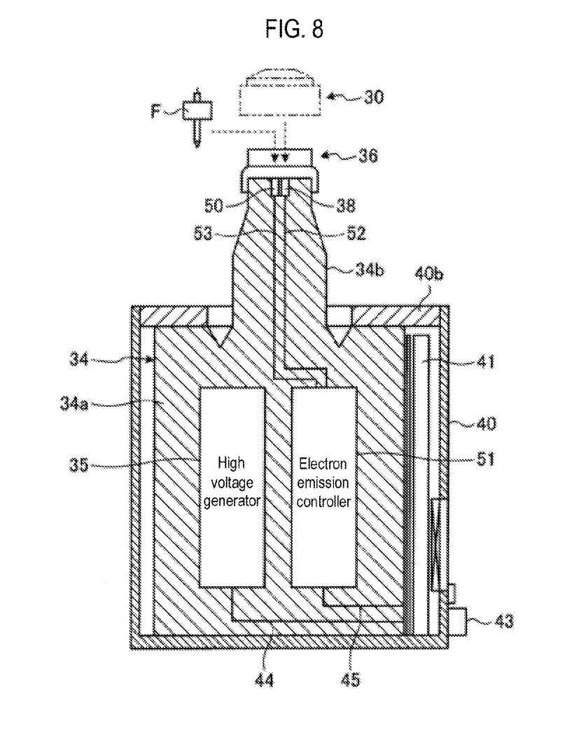

An X-ray generation device using the target for X-ray generation T1 will be described below. FIG. 7 is a view showing one example of the sectional configuration of an X-ray generation device using the target for X-ray generation T1 according to the first embodiment. FIG. 8 is a view showing one example of a mold power supply unit of the X-ray generation device using the target for X-ray generation T1 according to the first embodiment. The X-ray generation device described with reference to FIGS. 7 and 8 is just one example and the present disclosure is not limited thereto.

As will be described below, an X-ray generation device 21 includes an electron beam irradiation unit and a beam diameter controller. The electron beam irradiation unit irradiates an electron beam on a target for X-ray generation having a first X-ray target portion formed on the upper surface of a substrate and a second X-ray target portion which is formed at a position surrounding the first X-ray target portion in the upper surface of the substrate, while being spaced from the outer edge of the first X-ray target portion. The beam diameter controller controls the beam diameter of the electron beam irradiating the target for X-ray generation. In addition, the beam diameter controller allows a first X-ray, which indicates the resolution corresponding to the size of the first X-ray target portion, to be emitted from the target for X-ray generation, by setting a beam diameter to a size at which an irradiation range becomes a range including the first X-ray target portion but not including the second X-ray target portion. In addition, the beam diameter controller allows a second X-ray, which indicates the resolution lower than the resolution of the first X-ray, to be emitted from the target for X-ray generation, by setting the beam diameter to a size at which an irradiation range becomes a range including the first X-ray target portion and the second X-ray target portion. The electron beam emitted by the X-ray generation device 21 is not changed in its central position but is changed in its beam diameter.

Descriptions are returned to FIG. 7. The X-ray generation device 21 shown in the example of FIG. 7 is an open type different from a disposable closed type, and can optionally create a vacuum state. In the X-ray generation device 21, consumables such as a filament F or the target for X-ray generation T can be replaced with new ones. The X-ray generation device 21 has a cylindrical stainless housing 22 which is put in a vacuum state in operation. The cylindrical housing 22 is divided into two parts, i.e., a fixed part 23 located at the lower side and a removable part 24 located at the upper side. The removable part 24 is attached to the fixed part 23 via a hinge 25. Thus, the removable part 24 can be rotated via the hinge 25 so as to lie on its side, so that the top of the fixed part 23 is allowed to be opened. This makes it possible to access the filament (cathode) F accommodated in the fixed part 23.

A pair of upper and lower cylindrical coils 26 and 27 serving as an electromagnetic deflection lens is placed within the removable part 24. In the removable part 24, an electron channel 28 extends to pass through the center of the pair of coils 26 and 27 in the longitudinal direction of the cylindrical housing 22, while being surrounded by the pair of coils 26 and 27. A disc plate 29 is fixed to the lower end of the removable part 24 so as to serve as a lid and an electron introduction hole 29a aligned with the lower end side of the electron channel 28 is formed in the center of the disc plate 29.

The upper end of the removable part 24 is formed in a truncated conical shape. The target for X-ray generation T1 located on the upper end side of the electron channel 28 and forming an electron transmission type X-ray irradiation window is mounted on the top of the removable part 24. The target for X-ray generation T1 is accommodated in and grounded to a removable rotary cap 31. Therefore, the consumable target for X-ray generation T1 can be replaced with a new one by removing the rotary cap 31. In addition, the filament F is accommodated in a removable cap 30. Therefore, by dismounting the cap 30, the filament F can be replaced with a new one.

A vacuum pump 32 is fixed to the fixed part 23. The vacuum pump 32 is provided to put the entire inner space of the cylindrical housing 22 under a high vacuum state. That is, when the X-ray generation device 21 is equipped with the vacuum pump 32, the consumable filament F and target for X-ray generation T1 can be replaced with new ones.

A mold power supply unit 34 integrated with an electron gun 36 is fixed to the base end side of the cylindrical housing 22. The mold power supply unit 34 is obtained by molding an electrically-insulating resin (for example, an epoxy resin) and is accommodated in a metal case 40. The lower end (base end) of the fixed part 23 of the cylindrical housing 22 is fastened to an upper plate 40b of the case 40 by means of screws or the like in a state where the lower end is sealed.

A high voltage generation device 35 constituting a transformer for generating a high voltage (for example, up to 160 kV when the target for X-ray generation T1 is grounded) is sealed in the mold power supply unit 34, as shown in FIG. 8. Specifically, the mold power supply unit 34 is constituted by a lower rectangular block-shaped power supply body 34a and an upper columnar neck portion 34b projecting upward from the power supply body 34a into the fixed part 23. Since the high voltage generation device 35 is heavy, it is preferable that the high voltage generation device 35 is sealed in the power supply body 34a and is disposed as low as possible in consideration of the weight balance of the entire X-ray generation device 21.

The electron gun 36 is disposed on the leading end of the neck portion 34b such that it faces the target for X-ray generation with the electron channel 28 interposed therebetween.

As shown in FIG. 8, an electron emission controller 51 electrically connected to the high voltage generation device 35 is sealed in the power supply body 34a of the mold power supply unit 34 and controls a timing of electron emission, a tube current and so on. The electron emission controller 51 is connected to a grid terminal 38 and a filament terminal 50 via a grid connection wiring 52 and a filament connection wiring 53, respectively. The connection wirings 52 and 53 are sealed in the neck portion 34b since a high voltage is applied.

The power supply body 34a is accommodated in the metal case 40. A high voltage controller 41 is interposed between the power supply body 34a and the case 40. A power supply terminal 43 for connection to an external power supply is fixed to the case 40 and the high voltage controller 41 is connected to the power supply terminal 43 and, at the same time, is connected to the high voltage generation device 35 and electron emission controller 51 in the mold power supply unit 34 via wirings 44 and 45, respectively. Based on an external control signal, the high voltage controller 41 controls a voltage generated in the high voltage generation device 35 which constitutes a transformer, between a high voltage (for example, 160 kV) and a low voltage (for example, 0V). The electron emission controller 51 controls the timing of electron emission, the tube current and so on.

In the X-ray generation device 21, under the control of a controller (not shown), power and the control signal are supplied from the high voltage controller 41 in the case 40 to the high voltage generation device 35 and electron emission controller 51 in the mold power supply unit 34, respectively. At the same time, the power and the control signal are supplied to the coils 26 and 27. As a result, electrons are emitted from the filament F at an appropriate acceleration, are appropriately converged by the controlled coils 26 and 27 and are irradiated on the target for X-ray generation T1. When the irradiated electrons collide with the target for X-ray generation T1, an X-ray is externally emitted.

In this manner, in the X-ray generation device 21, the filament F irradiates the electron beam on the target for X-ray generation T1. In addition, in the X-ray generation device 21, the beam diameter of the beam emitted from the filament F is controlled by a controller (not shown), the high voltage controller 41 and the electron emission controller 51 and is further controlled by the coils 26 and 27. That is, the beam diameter is controlled by all of the controller (not shown), the high voltage controller 41, the electron emission controller 51 and the coils 26 and 27.

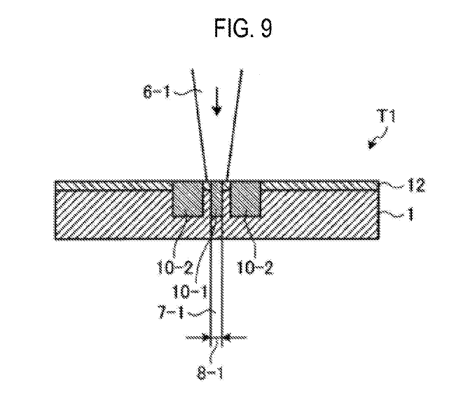

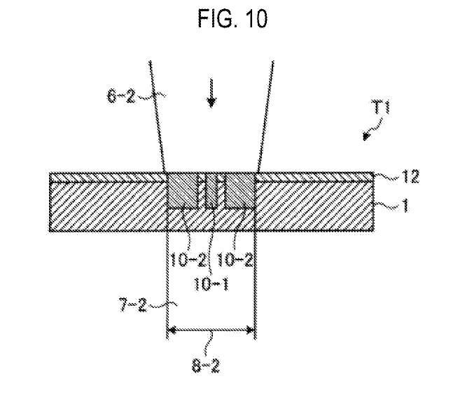

FIGS. 9 and 10 are views showing the relationship between the beam diameter of the electron beam irradiating the target for X-ray generation T1, the first X-ray target portion 10-1 and the second X-ray target portion 10-2. In FIGS. 9 and 10, an irradiation direction of the electron beam emitted from the filament F is indicated by an arrow. In FIGS. 9 and 10, the resolution of an X-ray 7 emitted from the target for X-ray generation T1 corresponds to the width of the X-ray 7.

As shown in FIG. 9, when the X-ray generation device 21 emits an electron beam 6-1 having a beam diameter at which the irradiation range becomes a range including the first X-ray target portion 10-1 and not including the second X-ray target portion 10-2, a first X-ray 7-1 indicating the resolution corresponding to the size of the X-ray target portion 10-1 is emitted from the target for X-ray generation T1. That is, in the X-ray generation device 21, even when an electron beam 6-1 having the beam diameter whose irradiation range becomes a range including the first X-ray target portion 10-1 and not including the second X-ray target portion 10-2 is irradiated, a first X-ray 7-1 indicating the resolution corresponding to the size of the X-ray target portion 10-1 is eventually emitted. In this case, the resolution of the first X-ray 8-1 corresponds to the width 7-1.

In addition, as shown in FIG. 10, in the X-ray generation device 21, an electron beam 6-2 having the beam diameter whose irradiation range becomes a range including the first X-ray target portion 10-1 and the second X-ray target portion 10-2 is emitted, a second X-ray 7-2 indicating the resolution lower than that of the first X-ray 7-1 is emitted from the target for X-ray generation T1. A case where an electron beam having the beam diameter larger than the outer diameter of the second X-ray target portion 10-2 is emitted is shown in the example of FIG. 10. That is, in the X-ray generation device 21, it is possible to emit a second X-ray 7-2 indicating the resolution lower than that of the first X-ray 7-1 by using the target for X-ray generation T1 which can emit the first X-ray 7-1 indicating the resolution corresponding to the size of the first X-ray target portion 10-1 even when an electron beam 6-2 having the beam diameter whose irradiation range becomes a range including the first X-ray target portion 10-1 and not including the second X-ray target portion 10-2 is emitted. The resolution of the second X-ray 7-2 (corresponding to the width 8-2) is lower than that of the first X-ray 7-1 (corresponding to the width 8-1). It is noted that as the width of X-ray becomes narrower, the resolution of X-ray becomes higher.

Incidentally, in the X-ray generation device, a high resolution can be obtained by accelerating the electrons with a high voltage (for example, about 50 to 150 keV) and finely focusing the accelerated electrons on the target. When the electrons lose their energy in the target, an X-ray (referred to as a so-called bremsstrahlung X-ray) is generated. At this time, the focus size is substantially determined depending on the size of the beam diameter of the emitted electron beam.

In order to obtain a fine X-ray focus size, it is necessary to focus the electrons on a small spot. In order to increase the amount of X-ray to be generated, it is necessary to increase the quantity of electrons. However, since the spot size of electrons and the amount of current are in a trade-off relationship with each other due to a space charge effect, a large current cannot be flown into a small spot. Further, if a large current is flown into a small spot, the target is highly likely to be exhausted (used up) due to heat generation.

As described above, in this embodiment, since the target for X-ray generation T1 includes the substrate 1 made of diamond, the first X-ray target portion 10-1 in close contact with the bottom face 3-1a and side wall face 3-1b of the hole 3-1, and the second X-ray target portion 10-2 in close contact with the bottom face 3-2a and side wall face 3-2b of the hole 3-2, it is possible to provide excellent heat dissipation and suppress consumption of the target for X-ray generation T1 even under the above-mentioned situations.

In addition, since the first X-ray target portion 10-1 is nano-sized, even when the electrons emitted with the above-described high voltage (for example, about 50 to 150 keV) are widened in width in the vicinity of the first X-ray target portion 10-1, it is possible to suppress increase in the X-ray focus diameter and reduction in the X-ray resolution. In other words, even if the beam diameter gets larger than the diameter of the first X-ray target portion 10-1, it is possible to emit an X-ray having the diameter corresponding to the diameter of the first X-ray target portion 10-1. In addition, it is possible to increase the amount of X-ray by increasing the depth of the first X-ray target portion 10-1. That is, it is possible to obtain the resolution determined depending upon the size of the first X-ray target portion 10-1. Therefore, the X-ray generation device 21 using the target for X-ray generation T1 can obtain a nano-order resolution (several tens to several hundreds nm) while increasing the amount of X-ray.

Moreover, as described above, the X-ray generation device according to the first embodiment includes the substrate, the electron beam irradiation unit and the beam diameter controller. The electron beam irradiation unit irradiates, with the electron beam, the target for X-ray generation having the first X-ray target portion formed on the upper surface of the substrate and the second X-ray target portion which is formed at the position surrounding the first X-ray target portion in the upper surface of the substrate while being spaced from the outer edge of the first X-ray target portion. The beam diameter controller controls the beam diameter of the electron beam irradiating the target for X-ray generation. In addition, the beam diameter controller allows a first X-ray, which indicates the resolution corresponding to the size of the first X-ray target portion, to be emitted from the target for X-ray generation, by setting a beam diameter to a size whose irradiation range becomes a range including the first X-ray target portion but not including the second X-ray target portion. In addition, the beam diameter controller allows a second X-ray, which indicates the resolution lower than the resolution of the first X-ray, to be emitted from the target for X-ray generation, by setting the beam diameter to a size whose an irradiation range becomes a range including the first X-ray target portion and the second X-ray target portion. As a result, it is possible to use X-rays having different resolutions.

In other words, by forming the first X-ray target portion 10-1 and the second X-ray target portion 10-2 having the diameter different from that of the first X-ray target portion 10-1 in the substrate 1, and by blurring the focus of the electron beam irradiating the target for X-ray generation T1 or changing the diameter of the electron beam emitted from the filament F and accordingly changing the irradiation range of the electron beam in the target for X-ray generation T1, it is possible to simply switch between X-rays having different resolutions.

### Other Embodiments

While the first embodiment has been described so far, embodiments other than the first embodiment may be implemented as described below. Thus, hereinafter, descriptions on other embodiments will be made.

### (Fabrication Method)

For example, although it has been illustrated in the above embodiment that the FIB is used to prepare the first X-ray target portion 10-1 and the second X-ray target portion 10-2, the present disclosure is not limited thereto but may employ any other methods.

### (Second X-Ray Target Portion)

In addition, although it has been illustrated in the above embodiment that one second X-ray target portion 10-2 is provided for the target for X-ray generation T1, the present disclosure is not limited thereto. For example, a plurality of second X-ray target portions 10-2 may be provided for the target for X-ray generation T1. That is, a plurality of second X-ray target portions 10-2 having a different diameter from the first X-ray target portion 10-1 may be provided for the target for X-ray generation T1.

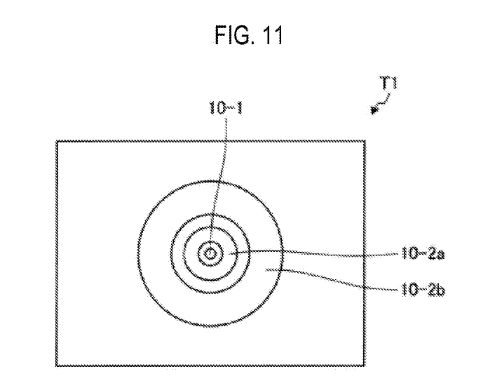

FIG. 11 is a view showing one example of the target for X-ray generation T1 in an embodiment where a plurality of second X-ray target portions is provided. A case where a second X-ray target portion 10-2a and a second X-ray target portion 10-2b are provided is shown in the example shown in FIG. 11. However, the present disclosure is not limited thereto, but the number of second X-ray target portions 10-2 may be optional. For convenience of description, FIG. 11 shows a top view of the target for X-ray generation T1.

In this manner, when the plurality of second X-ray target portions is provided, it is possible to simply and gradually switch between X-rays having different resolutions lower than that of the first X-ray stepwise. For example, in the example shown in FIG. 11, when an electron beam having the diameter larger than the outer diameter of the second X-ray target portion 10-2a and smaller than the inner diameter of the second X-ray target portion 10-2b is emitted, an X-ray corresponding to the outer diameter of the second X-ray target portion 10-2a can be emitted. In addition, when an electron beam having the diameter larger than the outer diameter of the second X-ray target portion 10-2b, an X-ray corresponding to the outer diameter of the second X-ray target portion 10-2b can be emitted. In other words, it is possible to simply switch between the X-ray corresponding to the outer diameter of the second X-ray target portion 10-2a and the X-ray corresponding to the outer diameter of the second X-ray target portion 10-2b, which are X-rays having resolutions lower than that of the first X-ray.

### (Beam Diameter of Electron Beam)

In addition, although it has been illustrated in the above embodiment that an electron beam having the beam diameter including the overall range of the second X-ray target portion 10-2 is used as the electron beam having the beam diameter whose irradiation range becomes a range including the first X-ray target portion 10-1 and the second X-ray target portion 10-2, the present disclosure is not limited thereto. For example, an electron beam having the beam diameter including only a partial range of the second X-ray target portion 10-2 rather than the overall range thereof may be used. In this case, the resolution of an X-ray emitted from the target for X-ray generation T1 corresponds to the beam diameter of the electron beam irradiating the target for X-ray generation T1, rather than the outer diameter of the second X-ray target portion 10-2.

### (Second X-Ray Target Portion)

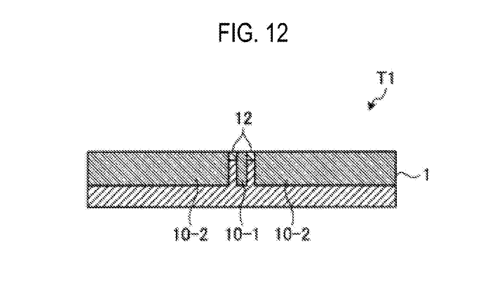

In addition, for example, as shown in FIG. 12, the second X-ray target portion 10-2 may be formed in an entire region positioned radially outward from a position spaced from the outer edge of the first X-ray target portion 10-1 and surrounding the first X-ray target portion 10-1 in the upper surface of the target for X-ray target T1. FIG. 12 is a view showing one example of the second X-ray target portion.

### (First X-Ray Target Portion and Second X-Ray Target Portion)

In addition, although it has been illustrated in the above embodiment that the first X-ray target portion 10-1 and the second X-ray target portion 10-2 are buried in the substrate 1, the present disclosure is not limited thereto. For example, the first X-ray target portion 10-1 may be buried in the bottomed hole 3-1, whereas the second X-ray target portion 10-2 may be formed on the surface of the substrate 1. In this case, for example, if the second X-ray target portion 10-2 is formed in a widened range of the upper surface of the substrate 1 compared with the first X-ray target portion 10-1, the second X-ray target portion 10-2 can be formed easily.

### (Second X-Ray Target Portion)

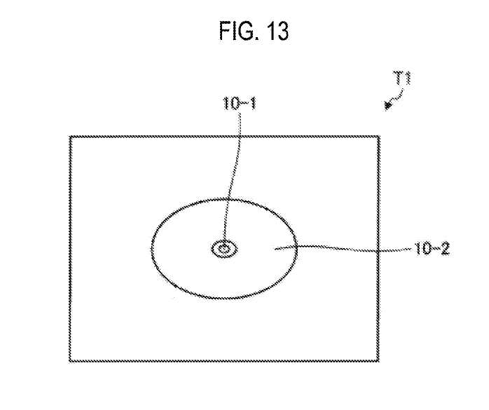

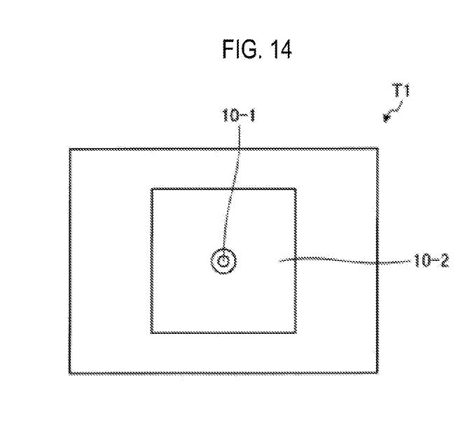

For example, although it has been illustrated in the above embodiment that the hole 3-2 is formed in the ring shape on the front surface 1a as shown in FIG. 2, the present disclosure is not limited thereto. For example, the hole 3-2 may be formed in an elliptical shape as shown in FIG. 13, a shape having one or more corners as shown in FIG. 14 or any other shapes. FIGS. 13 and 14 are views showing examples of the second X-ray target portion.

In addition, although it has been illustrated in the example shown in FIG. 13 that the second X-ray target portion 10-2 has the elliptical outer shape and the circular inner shape, the present disclosure is not limited thereto. For example, one or both of the outer and inner shapes of the second X-ray target portion 10-2 may be elliptical.

In addition, although it has been illustrated in the example shown in FIG. 14 that the second X-ray target portion 10-2 has the rectangular outer shape and the circular inner shape, the present disclosure is not limited thereto. For example, the second X-ray target portion 10-2 may have an outer shape having one to three corners or five or more corners. In addition, although it has been illustrated in the example shown in FIG. 14 that the second X-ray target portion 10-2 has the rectangular outer shape and the circular inner shape, the present disclosure is not limited thereto. For example, one or both of the outer and inner shapes of the second X-ray target portion 10-2 may have one or more corners.

### (Conductive Layer)

In addition, for example, although it has been illustrated in the above embodiment that the conductive layer 12 is formed to cover the front surface 1a of the substrate 1, the second end face 10-1b of the first X-ray target portion 10-1 and the second end face 10-2b of the second X-ray target portion 10-2 as shown in FIG. 3, the present disclosure is not limited thereto.

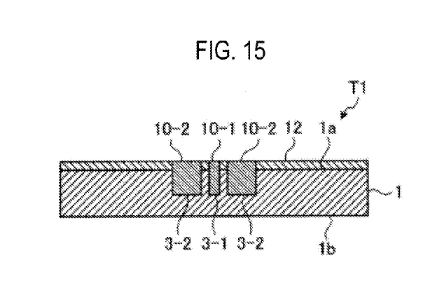

For example, as shown in FIG. 15, the conductive layer 12 may be formed on the front surface 1a in such a manner as to expose the second end face 10-1b of the first X-ray target portion 10-1 and the second end face 10-2b of the second X-ray target portion 10-2. FIG. 15 is a view for explaining one example of the sectional configuration of the target for X-ray generation. In this case, the target for X-ray generation is fabricated by forming the conductive layer 12 on the substrate before forming a hole, and then forming a target in the hole.

### EXPLANATION OF REFERENCE NUMERALS

1: substrate, 1a: front surface, 1b: rear surface, 10-1: first X-ray target portion, 10-2: second X-ray target portion, 12: conductive layer, T1: target for X-ray generation

1. A target for X-ray generation comprising:
a substrate;
a first X-ray target portion formed on an upper surface of the substrate; and
a second X-ray target portion formed at a position surrounding the first X-ray target portion in the upper surface of the substrate, while being spaced from an outer edge of the first X-ray target portion.

2. The target for X-ray generation of claim 1, wherein the second X-ray target portion is formed in a ring shape whose center is a position at which the first X-ray target portion is formed.

3. The target for X-ray generation of claim 1, wherein a plurality of second X-ray target portions is formed.

4. The target for X-ray generation of claim 1, wherein the first X-ray target portion and the second X-ray target portion are buried in bottomed hole portions formed in the substrate.

5. The target for X-ray generation of claim 1, wherein the first X-ray target portion is buried in a bottomed hole portion formed in the substrate and the second X-ray target portion is formed on a front surface of the substrate.

6. The target for X-ray generation of claim 1, further comprising a conductive layer formed on the upper surface of the substrate.

7. An X-ray generation device comprising:
an electron beam irradiation unit configured to irradiate an electron beam on a target for X-ray generation including a substrate, a first X-ray target portion formed on an upper surface of the substrate, and a second X-ray target portion formed at a position surrounding the first X-ray target portion in the upper surface of the substrate, while being spaced from an outer edge of the first X-ray target portion; and
a beam diameter controller configured to control a beam diameter of the electron beam irradiating the target for X-ray generation,
wherein the beam diameter controller allows a first X-ray, which indicates resolution corresponding to a size of the first X-ray target portion, to be emitted from the target for X-ray generation, by setting a beam diameter to a size at which an irradiation range becomes a range including the first X-ray target portion but not including the second X-ray target portion, and the beam diameter controller allows a second X-ray, which indicates resolution lower than the resolution of the first X-ray, to be emitted from the target for X-ray generation, by setting the beam diameter to a size at which an irradiation range becomes a range including the first X-ray target portion and the second X-ray target portion.
